(19) United States
(12) Patent Application Publication
(10) Pub. No.: US 2008/0204369 A1
(43) Pub. Date: Aug. 28, 2008

(54) System for Displaying Electronic Visual Messages Adjacent a Suspended Ceiling

(75) Inventor: Kevin L. Brown, Noblesville, IN (US)

Correspondence Address: INNOVATION LAW OFFICE OF DENNIS SCHELL, 133 WEST MARKET STREET # 256, INDIANAPOLIS, IN, 46204, US

(73) Assignee: MESSAGENET SYSTEMS, INC., Carmel, IN (US)

(21) Appl. No.: 12/113,054

(22) Filed: Apr. 30, 2008

Related U.S. Application Data
(63) Continuation of application No. 11/135,886, filed on May 24, 2005, now abandoned.

(51) Int. Cl. G09G 3/20

(52) U.S. Cl. 345/55

(57) ABSTRACT

A system for displaying visual messages below and adjacent a dropped ceiling grid includes an electronic visual messaging display having first and second end portions and a first and second bracket each having a proximal portion and a distal portion. Each pair of proximal and distal portions define substantially orthogonally oriented planes. The proximal portions are substantially flat and each attached to a respective end portion of the display. The distal portions are substantial flat and sufficiently thin to extend above the dropped ceiling.

### CROSS-REFERENCE TO RELATED APPLICATIONS

This application is a continuation of and claims the benefit of U.S. patent application Ser. No. 11/135,886, filed May 24, 2005, and titled Mounting Bracket for an LED Signal System, which is incorporated herein by reference.

### BACKGROUND

The present invention relates generally to the field of electronic visual messaging displays and systems, more particularly, to a system for displaying electronic visual messages adjacent and below a dropped or suspended ceiling grid.

### SUMMARY

The present invention may comprise one or more of the features recited in the attached claims, and/or one or more of the following features and combinations thereof.

Visual messaging systems, by their very nature, must be placed in locations where they are easily visible to their target audiences. In many cases, the visual messaging system comprises a visual message bar upon which text messages are displayed, either in a continuous or ‘running’ format. In environments such as schools or office buildings, the message bars are often positioned on the walls of rooms or hallways, or hung from suspended or dropped ceilings, and it is desirable for the message bars to be positioned high enough such that they are visible to most people filling the room or hall in which the bar is displayed. Often, the optimal viewing position for a message bar is at the ceiling line.

Traditional connectors used to attach the message bar directly to a wall include a bracket that is screwed directly to the wall. While structurally adequate, such connectors suffer from several drawbacks. For example, traditional connectors that affix directly to the wall require labor and time expenses (both in mounting the sign and in finding the location of a stud and drilling holes into the wall). Message bars, most often, are mounted to the wall between about one and about three feet below the ceiling line, not for optimized viewing reasons but because the use of traditional wall mounting brackets drives the choice of mounting in these locations. Further, relocating or removing message bar leaves holes marring the aesthetics of the wall. Moreover, the power and data cables required to run the message bar extend down the wall, further disturbing its aesthetic. Alternatively, message bars have been suspended from the ceiling, such as by chains or wires fastened to the ceiling or ceiling support members, but the same problems persists regarding the power and data cables.

Thus, there remains a need for an improved connection system for positioning message bars that does not require permanently marring the walls or ceiling and that eliminates the aesthetic problem of visibly running power and data cables over the walls and ceiling to the message bar.

In one illustrative embodiment, a public address messaging system is suspended below a dropped ceiling having a lattice of elongated support members defining a number of generally rectangular openings and a plurality of ceiling panel members, with each respective ceiling panel member positioned to fill a respective opening. This illustrative embodiment includes an elongated message bar having a front display portion extending between two oppositely disposed end portions and defining a first major axis and brackets extending from each respective end portion between a ceiling panel and a respective elongated support member and operationally connected to the respective support member. Each respective bracket further includes a substantially flat elongated proximal portion and a substantially flat elongated distal portion. One object of the present invention is to provide an improved connection member. Related objects and advantages of the present invention will be apparent from the following description.

Additional features of the disclosure will become apparent to those skilled in the art upon consideration of the following detailed description of the illustrative embodiment.

### BRIEF DESCRIPTION OF THE DRAWINGS

The detailed description particularly refers to the accompanying Figs. in which:

FIG. 1 illustrates a PRIOR ART connector system used to mount a message bar directly to a wall;

FIG. 2A is a perspective view of a connection bracket of a first illustrative embodiment;

FIG. 2B is a top plan view of the embodiment of FIG. 2A;

FIG. 2C is a front elevation view of the embodiment of FIG. 2A;

FIG. 2D is a side elevation view of the embodiment of FIG. 2A;

FIG. 3A is a perspective view of a mirror-image of the connection bracket of FIG. 2A;

FIG. 3B is a top plan view of the embodiment of FIG. 3A;

FIG. 3C is a front elevation view of the embodiment of FIG. 3A;

FIG. 3D is a side elevation view of the embodiment of FIG. 3A;

FIG. 4 is a front elevation view of a message bar incorporating the connectors of FIGS. 2A and 3A;

FIG. 5 is a rear elevation view of FIG. 4; FIG. 6A is a first side elevation view of FIG. 4;

FIG. 6B is a second side elevation view of FIG. 4;

FIG. 7 is a perspective view of FIG. 4;

FIG. 8 is a first perspective view of the illustrative embodiment of FIG. 4 and the ceiling grid of a dropped ceiling; and

FIG. 9 is a second perspective view of the illustrative embodiment of FIG. 4 and the ceiling grid of a dropped ceiling.

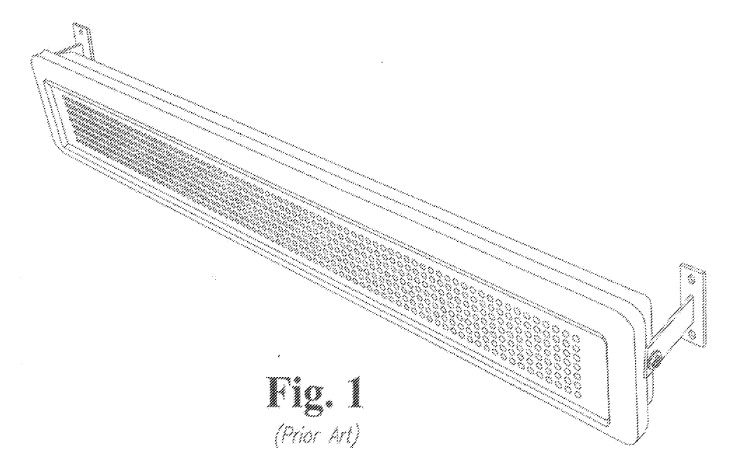

### DESCRIPTION OF THE ILLUSTRATIVE EMBODIMENTS

For the purposes of promoting an understanding of the principles of the invention and presenting its currently understood best mode of operation, reference will now be made to the embodiments illustrated in the drawings and specific language will be used to describe the same. It will nevertheless be understood that no limitation of the scope of the invention is thereby intended, with such alterations and further modifications in the illustrated device and such further applications of the principles of the invention as illustrated therein being contemplated as would normally occur to one skilled in the art to which the invention relates.

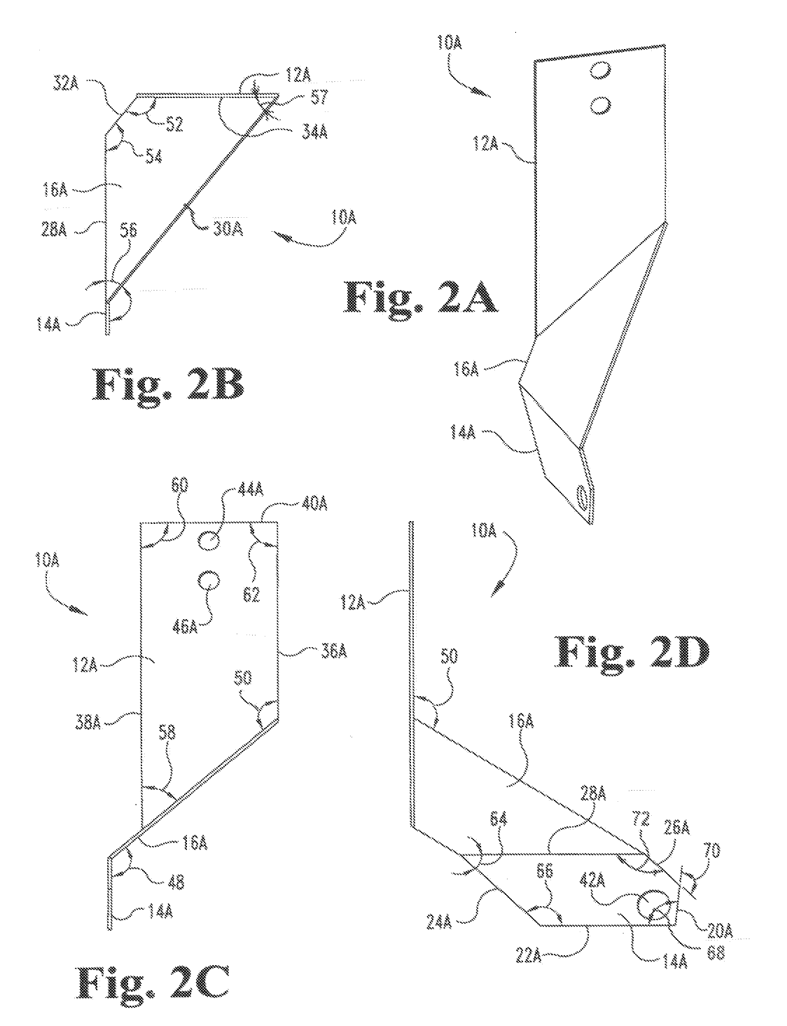

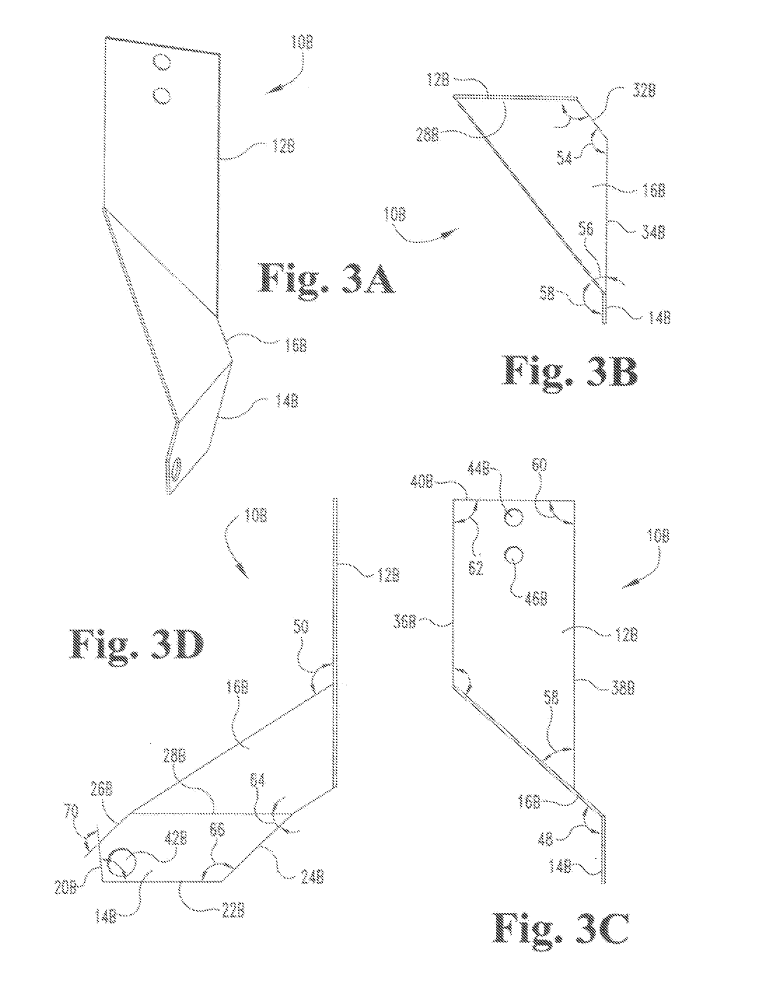

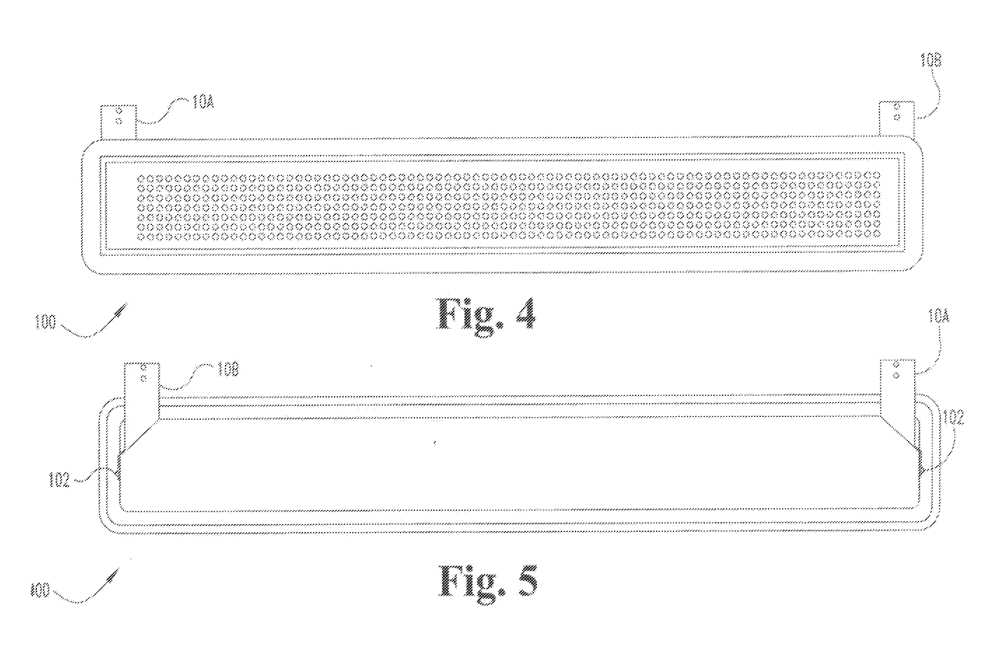

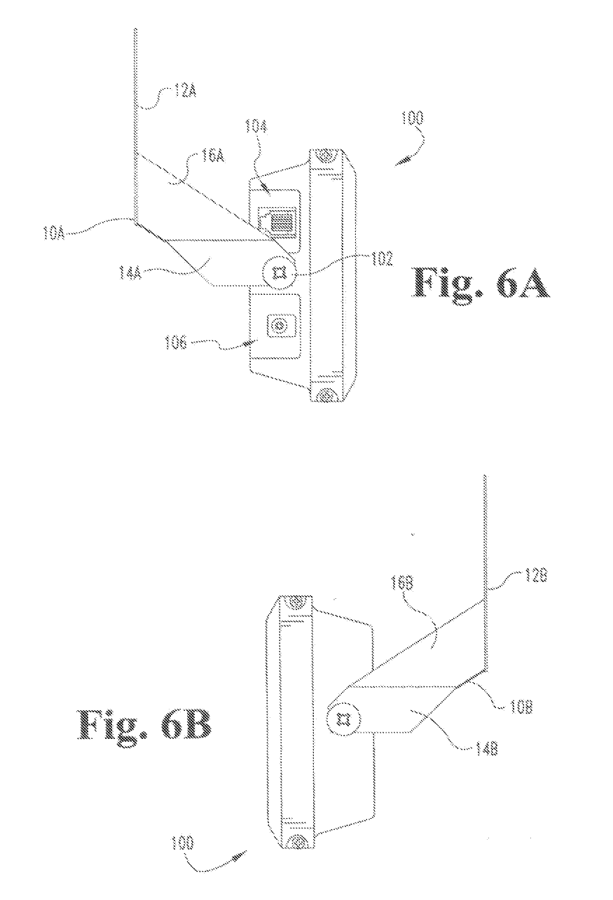

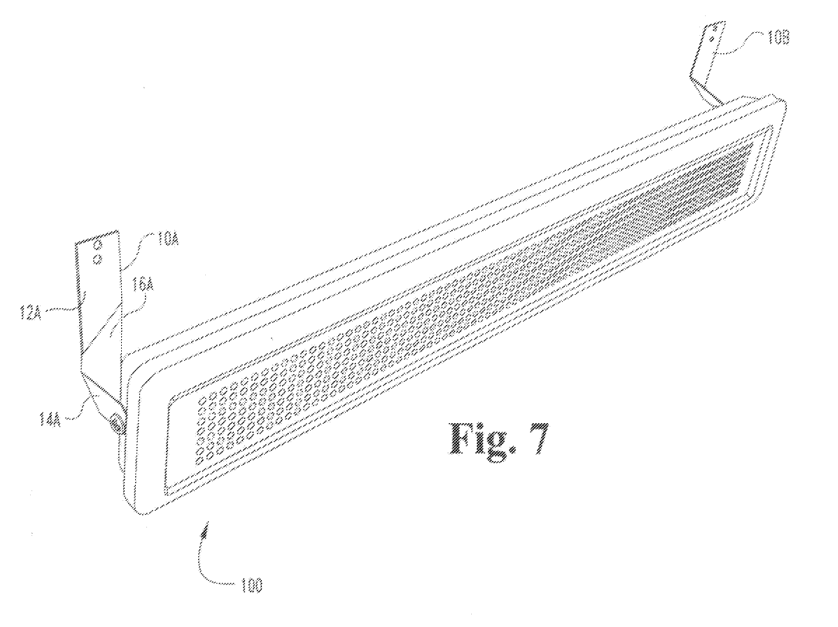

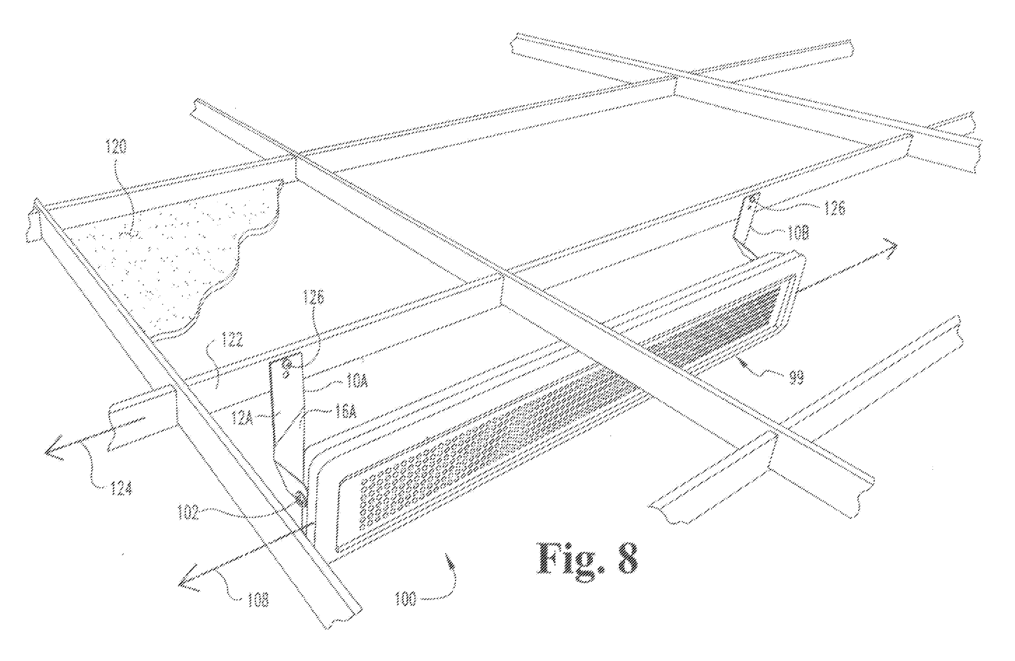

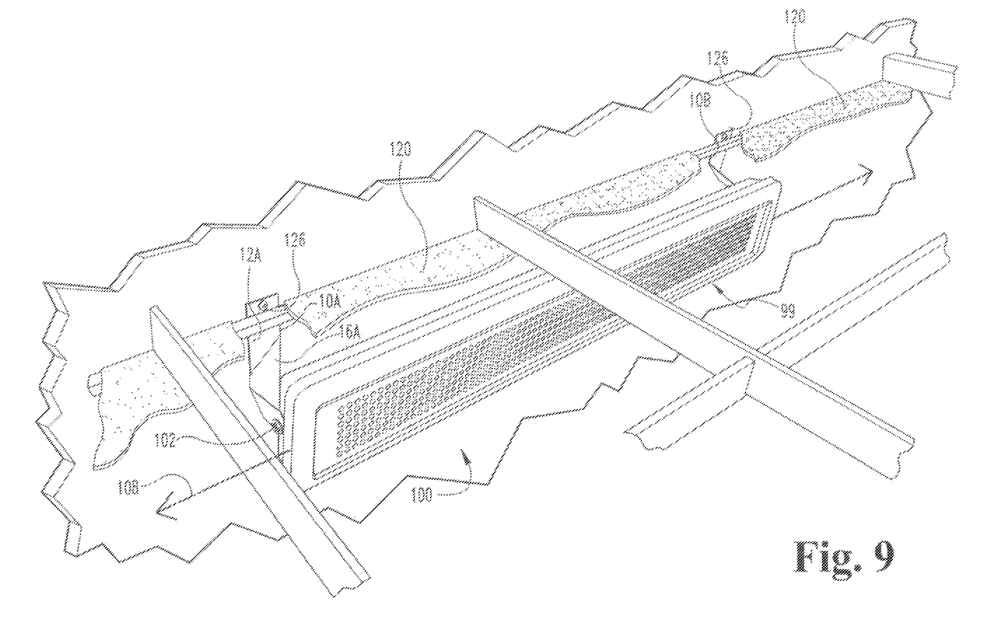

FIGS. 2A-9 relate to a first illustrative embodiment of the system, including an angled or “twisted” bracket 10A for supporting an elongated object, such as an LED message bar or the like, below a dropped ceiling. (The bracket 10B depicted in FIGS. 3A-3D is a mirror image of the bracket 10A shown in FIGS. 2A-2D; for simplicity, the bracket 10A of FIGS. 2A-2D will be discussed below in detail, with the understanding that such detailed discussion applies equally to the bracket 10B of FIGS. 3A-3D with allowances made for the bracket's 10B 180 degree rotational symmetry). The bracket 10A includes a first substantially flat, thin elongated member 12A connected to a second substantially flat, thin elongated member 14A turned about 90 degrees with respect to the first thin member 12A. In other words, the substantially flat, thin members 12A, 14A each define respective planes that are oriented substantially orthogonally with each other. The first and second thin members 12A, 14A are connected by a third substantially flat, thin elongated member 16A.

The bracket 10A is typically made of a structural material such as steel or aluminum, although other convenient structural materials may be selected. The bracket 10A is typically sufficiently thin such that the distal end 12A may extend between a ceiling panel (not shown) and an elongated member (not shown) of the ceiling panel support lattice (not shown) while still allowing the ceiling panel to properly fit into the support lattice without the necessity of a hole or slot being formed through the ceiling panel to accommodate passage of the distal end 12A. Typically, the bracket is about 0.65 millimeters thick, although the bracket may be thicker or thinner as necessitated by materials and/or processing requirements.

The proximal portion 14A is typically polygonal, more typically having a generally rectangular or pentagonal shape. In the illustrated embodiment, the proximal portion has five sides or edges 20A, 22A, 24A, 26A, 28A, with a first edge 20A of length of 0.9 units, a second edge 22A of length of 1.1 units, a third edge 24A of length of 2.9 units, a fourth edge 26A of length of 2.7 units and a fifth edge 28A of length of 4.4 units (typically, the units are centimeters). The second edge 22A extends between the first and third edges 20A, 24A; the fourth edge 26A extends between the third and fifth edges 24A, 28A; and the fifth 28A edge extends between the fourth and first edges 26A, 20A. The third edge 24A is also the proximal end 24A of the bracket 10A.

The intermediate portion 16A is likewise generally polygonal and is typically shaped as a parallelogram and defined by first, second, third and forth edges 28A, 30A, 32A, 34A, wherein the first edge is contiguous with the fifth edge 28A of the proximal portion 14A and is essentially the joint of the two 16A, 14A. Typically, the second and third edges 30A, 32A are disposed opposite each other and, more typically, in parallel with one another. In the illustrated embodiment, the first edge 28A has a length of 4.4 units, the second edge 30A has a length of 7.4 units, the third edge 32A has a length of 1.4 units, and the fourth edge 34A has a length of 4.2 units.

The distal portion 12A is also generally polygonal and is typically shaped as a parallelogram with a first edge 34A, a second edge 36A, a third edge 38A and a fourth edge 40A, wherein the first edge 34A is contiguous with the fourth edge 34A of the intermediate portion 16A and is essentially the joint of the intermediate and distal portions 16A, 12A. Typically, the second and third edges 36A, 38A are disposed opposite each other and, more typically, in parallel with one another. In the illustrated embodiment, the first edge 34A has a length of 4.2 units, the second edge 36A has a length of 5.0 units, the third edge 38A has a length of 8.0 units, and the fourth edge 40A has a length of 3.1 units. The fourth edge 40A is also the distal end 40A of the bracket 10A.

An aperture 42A is typically formed in the proximal portion 14A and one or a pair of apertures 44A, 46A are typically formed in the distal portion 12A. Typically, the apertures are circular, and more typically aperture 42A has a diameter of about 0.7 units while apertures 44A and 46A more typically have diameters of about 0.5 units. Alternately, different numbers of apertures may be formed, and/or the apertures 42A, 44A, 46A may have other convenient shapes and/or dimensions.

The proximal, intermediate, and distal portions 14A, 16A, 12A are typically flat thin members and more typically each portion 12A, 14A, 16A may be thought of as essentially defining a respective plane. The proximal and intermediate portions 14A and 16A (and their respective planes) intersect at a first intersection angle 48A and the distal and intermediate portions 14A and 16A (and their respective planes) intersect at an intersection angle 50A. Typically, angle 48A is about 145 degrees and angle 50A is about 115 degrees. More typically, the distal and proximal portions 12A, 14A are oriented substantially orthogonally with one another.

In the illustrated embodiment, the interior angles 52A, 54A, 56A and 57A defined between the edges 28A, 30A, 32A and 34A of the intermediate portion 16A are about 135 degrees, about 135 degrees, about 45 degrees and about 45 degrees, respectively. The angles are, of course, a function of the lengths of the respective edges 28A, 30A, 32A and 34A of the parallelogram, and would change with changes in the edge lengths. Likewise, the interior angles 50A, 58A, 60A and 62A defined between the edges 34A, 36A, 38A and 40A of the distal portion 12A are about 115 degrees, about 65 degrees, about 90 degrees and about 90 degrees, respectively, and would also change with any changes in the edge dimensions. Finally, the interior angles 64A, 66A, 68A and 70A and 72A defined between the edges 20A, 22A, 24A, 26A and 28A of the proximal portion 14A are about 45 degrees, about 135 degrees, about 115 degrees, about 115 and about 140 degrees, respectively, and would likewise change with any changes in the edge dimensions.

As is detailed in FIGS. 4-9, brackets 10A,B may be connected to an elongated object (such as a message bar) 99 to support it below a suspended ceiling and thus define an object or message bar suspension system. The brackets 10A, B are removably attached to the message bar 99, such as via fasteners 102 extended through apertures 42A, B and connected to the message bar 99. The message bar 99 typically includes a terminal for receiving data 104 and a terminal for receiving power 106; in some designs, the connection for receiving data 104 is unitary with the connection for receiving power. The length of the elongated message bar 99 defines a first major axis 108.

Each bracket 10A, B extends up and away from the message bar 99, with the proximal portion 14A, B generally oriented parallel with the generally flat end surfaces 110 of the message bar and the distal portions 12A, B oriented with their planes oriented generally parallel with the major axis 108.

In operation, the elongated object 99 is positioned below the ceiling panels 120 of a dropped ceiling. The proximal portions 14A, B of respective angled brackets 10A, B are attached to the opposite ends 102 of the elongated object 99. The distal portions 12A, B of each respective bracket 10A, B are extended between a ceiling panel 120 and an elongated support member 122 (defining a second major axis 124). The distal portions 12A, B are then repeatably removably attached thereto, such as via fasteners 126. The first major axis 108 is oriented substantially parallel to the second major axis 124 as defined by elongated support member 122. In this way, it is unnecessary to form additional holes or slots in the ceiling panels 120 to accommodate the brackets 10A, B, since placement of the system 100 is not dependent upon the length of the bar 99 being an integral multiple of a side length of the ceiling panels 120.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make an infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

1. A system for displaying visual messages adjacent a dropped ceiling grid forming a ceiling plane, comprising:
a visual messaging display having first and second end portions; and
a first and second bracket each having a proximal portion and a distal portion, the proximal portions substantially flat and the distal portions substantially flat, each proximal portion oriented substantially perpendicular to the respective distal portion;
the proximal portion of the first bracket coupled to the first end portion of the visual messaging display;
the proximal portion of the second bracket coupled to the second end portion of the visual messaging display;
each distal portion including:
a first edge;
a mounting feature defined adjacent the first edge; and
a second edge located opposite the first edge and coupled to the proximal portion; and
the first and second brackets positioned relative to the dropped grid ceiling such that the mounting feature is located above the ceiling plane and the second edge is located below the ceiling plane, thereby locating the visual messaging display below the dropped grid ceiling and hiding the mounting feature above the ceiling plane.

2. The system of claim 1, wherein the distal portions are adapted so that the first and second brackets can be slid into their positions relative to the dropped grid ceiling without modification of the dropped grid ceiling.

3. The system of claim 2, wherein the distal portions are sufficiently thin to be slid into their positions relative to the dropped grid ceiling without modification of the dropped grid ceiling.

4. The system of claim 2, wherein the distal portions are about 0.65 mm thick.

5. The system of claim 1, wherein the first and second brackets each further include an intermediate portion coupling the second edge of the distal portion and the proximal portion.

6. The system of claim 5, wherein the intermediate portion is substantially flat and is oriented obliquely with at least one axis of each of the proximate portion and the distal portion.

7. The system of claim 6, wherein the distal, intermediate, and proximate portions of each of the first and second bracket is a rhomboidal elongate member having a first bend forming the intersection of the distal and intermediate portions and a second bend forming the intersection of the intermediate and proximal portions.

8. The system of claim 1, wherein the visual messaging display comprises an electronic display.

9. The system of claim 1, wherein the distal portion includes a central portion between the first edge and the second edge, the intermediate portion abutting a member of the ceiling grid.

10. The system of claim 1, wherein the visual messaging display includes a unitary connector for receiving data and power.

11. A system for displaying visual messages adjacent a dropped ceiling grid forming a ceiling plane, comprising:
an electronic visual messaging display having first and second end portions; and
a first and second bracket each having a proximal portion and a distal portion, the proximal portions substantially flat and the distal portions substantially flat, each proximal portion oriented substantially perpendicular to the respective distal portion;
the proximal portion of the first bracket coupled to the first end portion of the visual messaging display;
the proximal portion of the second bracket coupled to the second end portion of the visual messaging display; and
each distal portion including:
a first edge;
a mounting feature defined adjacent the first edge; and
a second edge located opposite the first edge and coupled to the proximal portion;
the first and second brackets positioned relative to the dropped grid ceiling such that the mounting feature is located above the ceiling plane and the second edge is located below the ceiling plane, thereby locating the visual messaging display below the dropped grid ceiling and hiding the mounting feature above the ceiling plane; and
the distal portions of the first and second brackets adapted so that the first and second brackets can be slid into their positions relative to the dropped grid ceiling without modification of the dropped grid ceiling.
